(19) United States
(12) Patent Application Publication
(10) Pub. No.: US 2013/0036675 A1
(43) Pub. Date: Feb. 14, 2013

(54) DOOR PEEPHOLE BLOCKING DEVICE

(71) Applicants: Marc Burton, New Albany, OH (US); Jeffery A. Smith, Cape Coral, FL (US)

(72) Inventors: Marc Burton, New Albany, OH (US); Jeffery A. Smith, Cape Coral, FL (US)

(21) Appl. No.: 13/208,192

(22) Filed: Aug. 11, 2011

(51) Int. Cl. E06B 7/30

(52) U.S. Cl. 49/386; 49/395

(57) ABSTRACT

A device for selectively blocking unauthorized reverse viewing to the inside of a room through a door peephole comprising a main body, enclosure plate, actuating rod and rotating disc. The actuating rod and rotating disc include a first and a second locking means, respectively, which engage each other. When the actuating rod is moved in a first direction, the rotating disc rotates to align the opening of the rotating disc with the opening of the enclosure plate to allow visual access. When the actuating rod is moved in a second direction, the opening of the rotating disc will misalign the opening of the enclosure plate to block visual access. The device remains either in an open or in a closed position until a person inside the room moves the actuating rod. The device functions without an actuating rod if a user manually turns the rotating disc with his finger.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

This invention relates to door peephole viewers, and more particularly to a door peephole blocking device that prevents unauthorized reverse viewing from the outer side of the door peephole. For security purposes and to determine the identity of the person standing outside of a room seeking permission to enter, various types of door viewers have been developed.

Door peepholes are usually installed in the entry doors of apartment hotel rooms and sometimes condominiums and homes. The peephole often consists of a lens system through which a person inside the room can get a wide angle view of the outside. They allow a person to ascertain who is at the exterior of the entry door without actually unlocking and opening the entry door. However, the interior of the room can be visible in a limited manner by the person on the outside, while looking through the opposite end of the peephole which is not intended to magnify viewing. Through the use of a magnifying glass or other special equipment, it is possible to fully view the inside of a room from the outside, thereby resulting in the violation of a person's privacy.

Various types of door viewers have been developed. U.S. Pat. No. 5,078,470 issued to Milman on Jan. 7, 1992 defines a door mounted security peephole providing an undistorted view over a large area by use of a beam splitter optical system. The device has a door mounted housing containing a beam splitter and a light source arranged so that light is reflected from the beam splitter and toward the door exterior. An observer from inside the room may view the door exterior including a visitor at the door entrance. The visitor, however, cannot see the observer through the beam splitter because of the light reflected from the beam splitter.

U.S. Pat. No. 6,779,305 issued to Harter on Aug. 26, 2004 describes a conventional commercial door viewer plug which includes a lens at one end for providing a wide angle view and a hollow end through which a person would look. A truncated cone shaped plug fits within the hollow end to block light transmission through the door viewer. The plug is manually removable to use the door viewer and includes a removable lanyard to tether the plug in proximity to the door viewer.

U.S. Pub. No. 20060260196 entitled to Cheng on Nov. 23, 2006 describes an eyehole apparatus installed on the door peephole. The eyehole device includes an image capture device. When someone rings the door bell or the user in the house activates the eyehole apparatus, the image capture device captures the views outside the door for displaying on a flat panel display device. A storage device is included for recording the current view or previous views to constantly monitor the conditions outside the door.

U.S. Pub. No. 20110099907 entitled to Anderson on May 5, 2011 describes a door viewer blocker for selectively blocking a view through a door viewer. The device includes a ring mounted over a door viewer. The ring encircles the door viewer and a cover rotatably coupled to the ring.

All the devices and methods mentioned above have considerable draw backs for blocking unauthorized reverse viewing through a door peephole. Even though each of the devices discussed above provide a means for blocking door peephole viewing from the exterior, most of them failed to provide a simple system to block the unauthorized reverse viewing through the door peephole. The conventional door peephole blocker failed to provide a means to continuously keep the door peephole either in an open or closed position, without any manual intervention or use of electronics or illuminating devices. This is cumbersome for some persons who wish to keep the door peephole in a continuously open or closed position, and who do not wish to purchase high-technology devices to achieve this end.

Therefore, an object of the present embodiment is to provide a device which would block the unauthorized reverse viewing through the door peephole. A person inside the room would be able to keep the door peephole in an open position or in a closed position once the device is set.

### SUMMARY

The present invention is a device for blocking unauthorized reverse viewing to the inside of a room through a door peephole by a person standing outside. The device is installed on the entry doors of condominiums, homes, commercial offices, and any place with an entry door. It comprises an enclosure plate, a rotating disc, and an actuating rod which are enclosed inside a main body. The actuating rod is secured inside a housing. The enclosure plate and the rotating disc are provided with openings. The enclosure plate is fixed to the door using a variety of attaching means. While installing the device, the openings of the enclosure plate and the rotating disc are aligned with the door peephole. The enclosure plate remains fixed in one position while only the rotating disc opens or closes visual access when rotated by the actuating rod.

Ridges and furrows are provided on the surface of the actuating rod and on the periphery of the rotating disc. Both the ridges engage each other so that when the actuating rod is moved in a particular direction, the ridges on the actuating rod will force the rotating disc to rotate either in a first direction or in a second direction. The actuating rod can be moved in two directions, the direction may be decided by the alignment of the enclosure plate. When the actuating rod is moved in a desired direction, the rotating disc rotates in a first direction to align the openings of the enclosure plate and the rotating disc and allows visual access to the outside of the room through the device. When the actuating rod is moved in the second direction, the alignment of the openings of the enclosure plate and the rotating disc will change and block visual access to the inside of the room by a person standing outside. The device would remain either in an open or close position until the person inside the room moves the actuating rod in the second direction.

### BRIEF DESCRIPTION OF THE FIGURES

FIG. 1 is a perspective view of a door peephole blocking device.

FIG. 2 is a rear view of the door peephole blocking device.

FIG. 3 is a front view of the door peephole blocking device wherein an actuating rod, an enclosure plate and a rotating disc are shown as separate pieces.

FIG. 4A shows an alternate embodiment of the invention wherein the invention is spring loaded. FIG. 4B shows the alternate embodiment with a molded mushroom pin.

### REFERENCE NUMERALS

10 . . . A device for blocking door peephole according to the present invention
12 . . . Main Body
14 . . . Enclosure Plate
16 . . . Actuating Rod
18 . . . Housing
20 . . . Rotating Disc
22 . . . First Opening
24 . . . Second Opening
26 . . . First Locking Means
28 . . . Second Locking Means
30 . . . Screw Hole
32 . . . Spring
34 . . . Molded Mushroom Pin

### DETAILED DESCRIPTION

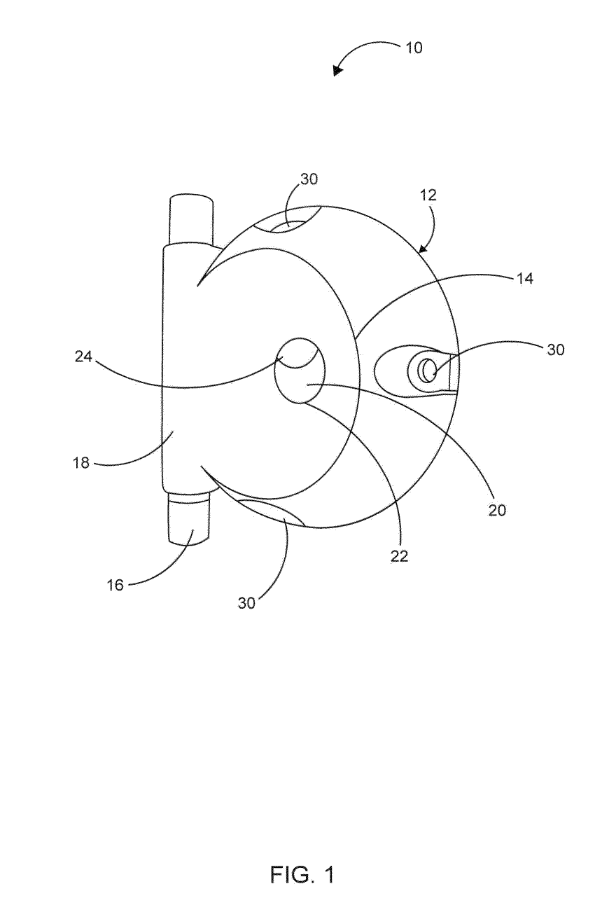

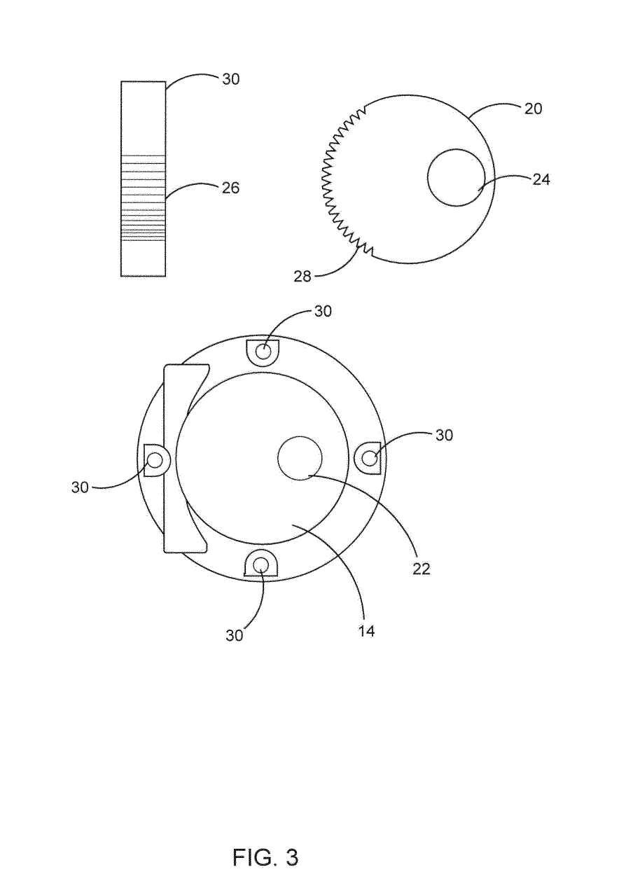

Referring to the drawings, a preferred embodiment illustrates a device 10 for blocking unauthorized reverse viewing to the inside of a room through a door peephole by a person standing outside. FIG. 1 shows a perspective view of a door peephole blocking device 10. The device 10 can be installed on any type of entry door. The device 10 includes a main body 12 that encloses an enclosure plate 14 having a front portion which is bulged outwards for receiving a rotating disc 20 (See also FIG. 3). The enclosure plate 14 has a first opening 22 which may be in a circular shape. A housing 18 for enclosing an actuating rod 16 is provided on the enclosure plate 14. The enclosure plate 14 is fixed to a door using a variety of attaching means including screwing the enclosure plate 14 to the door. A plurality of screw holes 30 is provided on the main body 12 to fix it to the door. The enclosure plate 14 is attached to the door with the first opening 22 of the enclosure plate 14 aligning with the door peephole. The rotating disc 20 under the front bulge portion of the enclosure plate 14 may be of circular shape and has an opening 24. The enclosure plate 14 remains fixed in one position. When the actuating rod 16 is adjusted by a person inside the room, the rotating disc 20 opens or closes visual access when rotated by the actuating rod 16 and the device 10 keeps visual access either continuously opened or continuously closed without having to hold the actuating rod 16.

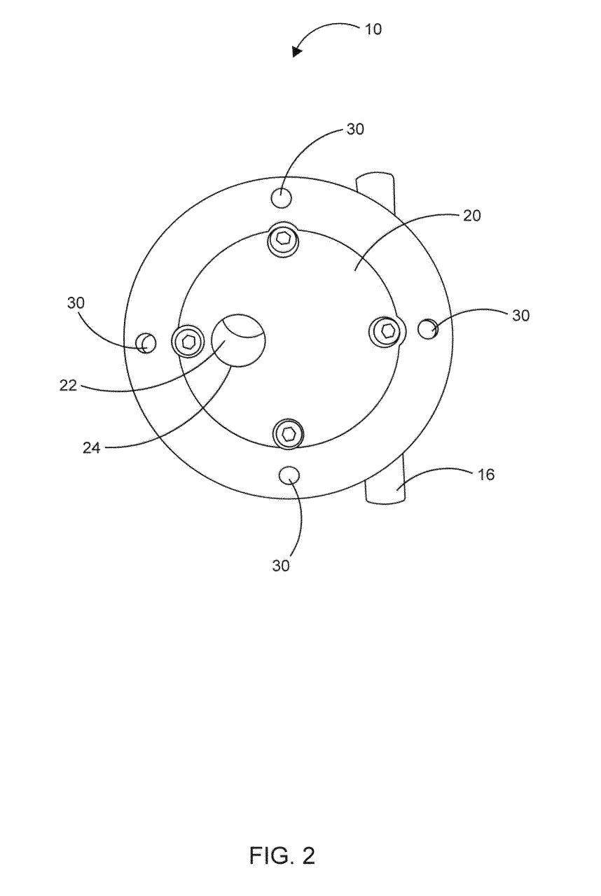

FIG. 2 shows a rear perspective view of the device 10 illustrating the back portion of the device 10 which comes in contact with the door peephole. The bottom portion is mounted on the door peephole using screws. While installing the device 10 the first opening 22 of the enclosure plate 14 and the second opening 24 of the rotating disc 20 should operatively align with the door peephole. When the actuating rod 16 is moved, the rotating disc 20 rotates in a first direction to align the first opening 22 with the second opening 24 to allow visual access to the outside of the room through the device 10. When the actuating rod 16 is moved in a second direction, the alignment of the first opening 22 with the second opening 24 will change to block visual access to the inside of the room by a person standing outside.

FIG. 3 shows a front view of the door peephole blocking device 10 illustrating the enclosure plate 14, the actuating rod 16 and the rotating disc 20 as separate pieces. A first locking means 26 is provided on the surface of the actuating rod 16 and a second locking means 28 is provided on the periphery of the rotating disc 20. The first locking means 26 and the second locking means 28 may be ridges and furrows. The second locking means 28 provided on the periphery of the rotating disc 20 may cover only a sector of the rotating disc 20, sufficient to rotate the rotating disc 20 to allow or block visual access. The first locking means 26 and the second locking means 28 engage with each other so that when the actuating rod 16 is moved in a particular direction, the rotating disc 20 will be forced to rotate either in a first or second direction. Depending upon the alignment of the enclosure plate 14, the actuating rod 16 can be moved up, down, sideways or diagonally. However, it should also be understood that the rotating disc can be rotated manually without an actuating disc, wherein the user uses his finger as an actuating rod to manually rotate the rotating disc by engaging the second locking means of the rotating disc.

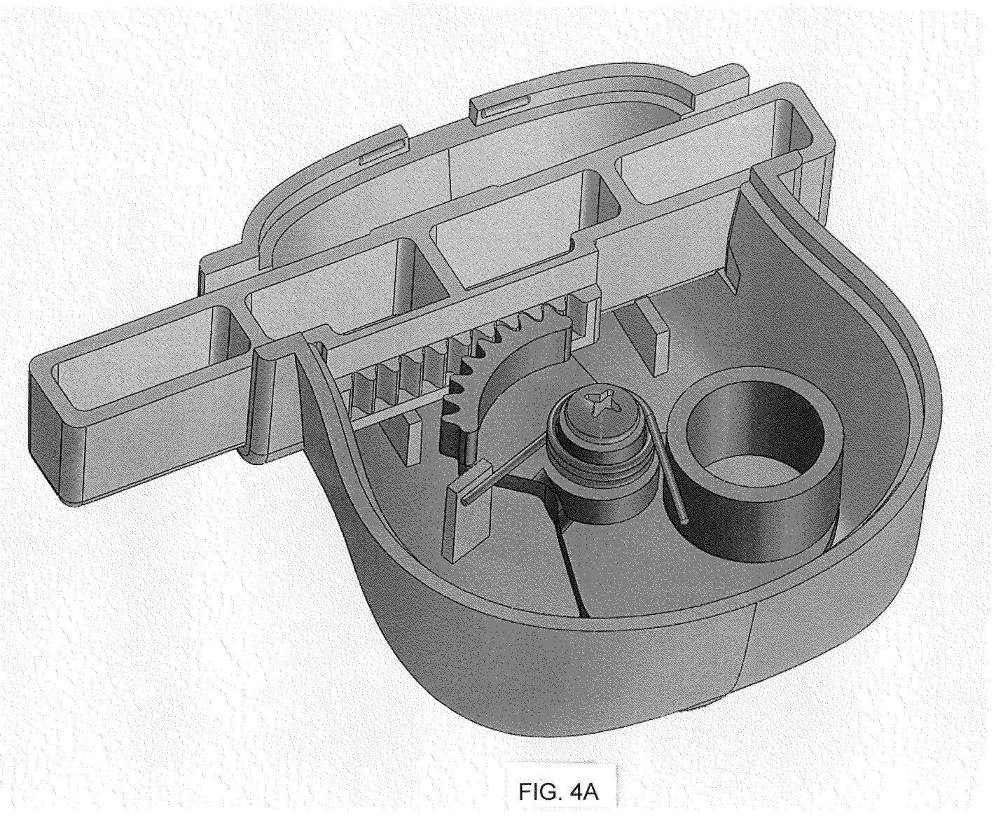

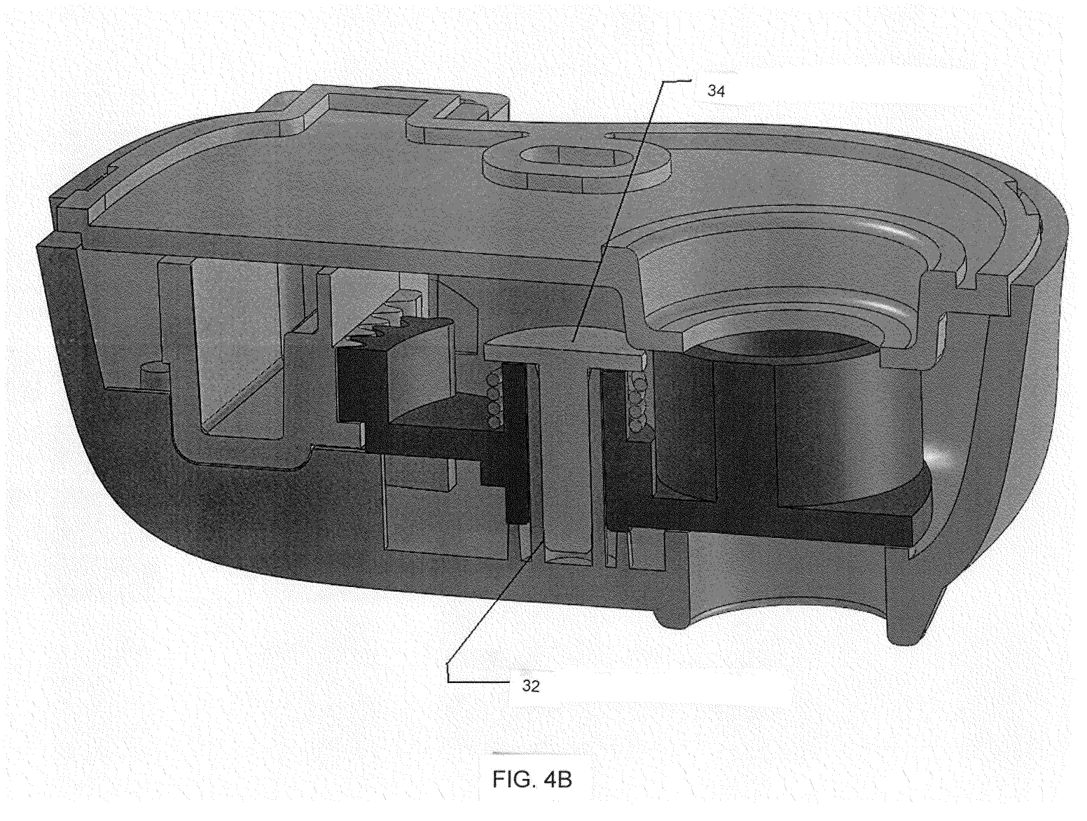

FIGS. 4A and 4B shows an alternate embodiment of the invention in which the invention is spring-loaded with a molded mushroom pin press-fit at the bottom of the pin.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

What is claimed is:

1. A device for blocking unauthorized visual access to the inside of a room through a door peephole comprising:
a main body;
an enclosure plate with a first opening, the first opening being aligned with the door peephole;
a rotating disc with a second opening and a second locking means, and
an actuating rod designed to move in a first direction and a second direction, and comprising a first locking means;
whereby the actuating rod moves in a first direction to align the first opening with the second opening to allow visual access and maintain the device in an open position, and the actuating rod moves in a second direction to change the alignment of the first opening with the second opening to block visual access and maintain the device in a closed position.

2. The device of claim 1, wherein the enclosure plate further comprises a housing for enclosing the actuating rod.

3. The device of claim 1, wherein the main body further comprises a plurality of screw holes for affixing the device to an entry door.

4. The device of claim 1 wherein the first locking means is arranged on a surface of the actuating rod and the second locking means is arranged on a periphery of the rotating disc.

5. The device of claim 4, wherein the first locking means and second locking means are ridges or furrows.

6. The device of claim 1 wherein the first locking means engages the second locking means to rotate the rotating disc and maintain the rotating disc in one position.

7. The device of claim 1 wherein the rotating disc rotates to align the second opening with the first opening to enable visual access through the door peephole, and rotates to misalign the second opening with the first opening to disable visual access through the door peephole.

8. The device of claim 1, wherein the device is spring-loaded.

9. A device for blocking unauthorized visual access to the inside of a room through a door peephole comprising:
a main body;
an enclosure plate with a first opening, the first opening being aligned with the door peephole; and
a rotating disc with a second opening and a locking means,
whereby a user uses his finger to engage the locking means and rotate the rotating disc a first direction, in order to align the first opening with the second opening and allow visual access, or a second direction, in order change the alignment of the first opening with the second opening and block visual access.
